(19) United States
(12) Patent Application Publication
(10) Pub. No.: US 2011/0161303 A1
(43) Pub. Date: Jun. 30, 2011

(54) SYSTEM AND METHOD FOR ANALYZING OFFICIAL NOTICES OF ELECTRONICALLY FILED PATENT APPLICATIONS

(75) Inventors: CHUNG-I LEE, Tu-Cheng (TW); HAI-HONG LIN, Shenzhen City (CN); DE-YI XIE, Shenzhen City (CN); ZHENG-CAI ZHU, Shenzhen City (CN); HAI-YUN CHEN, Shenzhen City (CN); SHUAI-JUN TAO, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/817,217

(22) Filed: Jun. 17, 2010

(30) Foreign Application Priority Data
Dec. 30, 2009 (CN) 200910312803.X

(51) Int. Cl. G06F 17/30; G06F 9/44; G06F 15/16

(52) U.S. Cl. 707/691; 719/328; 709/203; 707/827; 707/E17.006; 707/E17.007

(57) ABSTRACT

A system and method for analyzing official notices of an electronically filed patent application are based on a file server that connects to patent office websites, a database, and client computers. An official notice of the patent application is downloaded from one of the patent office websites according to a download command from one of the client computers, and is converted to an image format document. Character data of the image format document are identified, and patent information of the electronically filed patent application are extracted from the character data using a regular expression. In addition, the patent information are analyzed to generate analysis results of the official notice according to the comparison.

### BACKGROUND

1. Technical Field

Embodiments of the present disclosure relate generally to document analysis, and more particularly to a system and method for analyzing official notices of an electronically filed patent application.

2. Description of Related Art

In recent years, numerous patent offices, such as the United States Patent and Trademark Office (USPTO), European Patent Office (EPO), State Intellectual Property Office of People's Republic of China (SIPO), and Japanese Patent Office (JPO), have popularized electronic filing of patent applications. The patent office may issue one or more filling receipts when a patent application is filed electronically, or send one or more official notices during the examination process of the patent application. Often, the official notices must be processed manually, which can include viewing the notices, and acquiring information therefrom, such as an application number, filing date, and fee payment, and updating file information of the patent application correspondingly. Such conventional processing is redundant and inefficient, and error-based inaccuracy is difficult to avoid.

What is needed, therefore, is a system and method which can analyze official notices of an electronically filed patent application automatically, so as to increase efficiency and accuracy.

### BRIEF DESCRIPTION OF THE DRAWINGS

FIG. 1 is a schematic diagram of one embodiment of a file server including an official notice analysis system.

FIG. 2 is a block diagram of one embodiment of the file server of FIG. 1.

FIG. 3 is a flowchart of one embodiment of a method for analyzing official notices of an electronically filed patent application using a system, such as, for example, that of FIG. 1.

FIG. 4 is a flowchart of detailed descriptions of block S32 in FIG. 3.

FIG. 5 is a flowchart of detailed descriptions of block S34 in FIG. 3.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

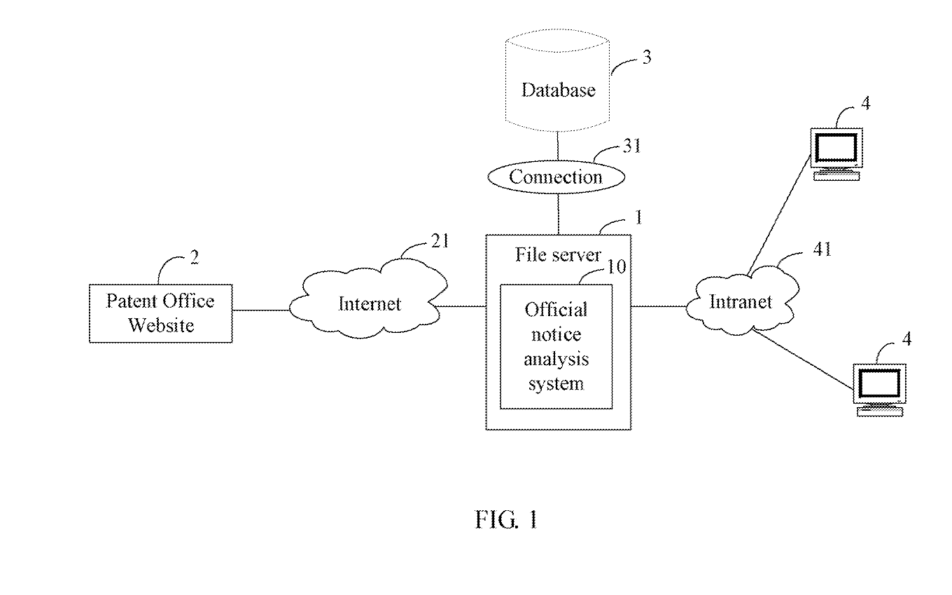

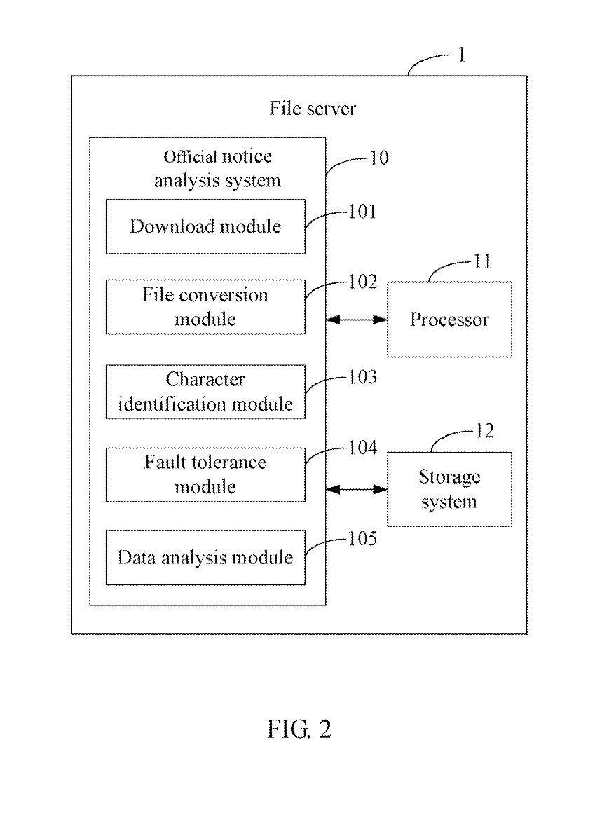

FIG. 1 is a schematic diagram of one embodiment of a file server 1 including a official notice analysis system 10. The official notice analysis system 10 is used to analyze official notices of an electronically filed patent application, and includes a plurality of functional modules (see in FIG. 2). In one embodiment, the official notices are sent from a patent office during an examination process of the patent application, and may include filling receipts, office actions, notices to file corrected application papers, and notices of missing parts, for example. In one embodiment, the file server 1 may be a computing device such as a computer, or an application server, for example. The file server 1 connects to a plurality of patent office websites 21 through the Internet 21, and connects to a database 3 via a connection 31, such as an open database connectivity (ODBC), or a Java database connectivity (JDBC), for example. The file server 1 may further connect to a plurality of client computers 4 through an Intranet 41. In one embodiment, the patent office websites 2 are websites maintained by the patent offices, such as United States Patent and Trademark Office (USPTO), European Patent Office (EPO), State Intellectual Property Office of People's Republic of China (SIPO), and Japanese Patent Office (JPO).

The database 3 stores basic information of patent applications and official notices issued from the patent office websites 2, and processes the basic information. Processing the basic information includes reading, writing, deleting, modifying, updating, and backing up the basic information, for example. In one embodiment, the basic information may include an application number, a filing date, a title of the invention, status of fee payment, and the name of the examiner, for example. Each of the client computers 4 is operable to receive one or more official notices of an electronically filed patent application from one patent office website 2 during the examination process of the patent application, and display analysis results generated by the notice analysis system 10.

FIG. 2 is a block diagram of one embodiment of the file server 1 included in FIG. 1. The file server 1 may include at least one processor 11, a storage system 12, and the official notice analysis system 10. In one embodiment, the official notice analysis system 10 may include a plurality of functional modules including one or more computerized codes. The at least one processor 11 executes the one or more computerized codes of the official notice analysis system 10 to analyze the official notices of the electronically filed patent applications. The storage system 12 may be an internal storage system, such as a random access memory (RAM) for temporary storage of information and/or a read only memory (ROM) for permanent storage of information. The storage system 12 may also be an external storage system, such as a hard disk, a storage card, or a data storage medium.

In one embodiment, the official notice analysis system 10 includes a download module 101, a file conversion module 102, a character identification module 103, a fault tolerance module 104, and a data analysis module 105. One or more computerized codes of the function modules 101-105 may be stored in the storage system 12 and executed by the at least one processor 11. In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. The modules described herein may be implemented as either software and/or hardware modules and may be stored in any type of computer-readable medium or other storage system.

The download module 101 is operable to download an official notice of the electronically filed patent application from one of the patent office websites 2 according to a download command from one of the client computers 4. In addition, the download module 101 is operable to identify a document type of the official notice according to an official patent code predefined by a patent office. In one embodiment, the official patent code may be “APP.FILE.REC” or “CNTF”. If the official patent code is “APP.FILE.REC”, the download module 101 determines that the official notice is the filling receipt of the electronically filed patent application. If the official patent code is “CNTF”, the download module 101 determines that the official notice is the office action for the electronically filed patent application.

The file conversion module 102 is operable to convert the official notice to an image format document using a document conversion function. In one embodiment, the image format document may be a JPG format document, or a TIF format document. The document conversion function may be an application programming interface (API) provided by the Microsoft Windows operating system.

The character identification module 103 is operable to identify character data from the image format document using a character identification function. In one embodiment, the character data may include information regarding the application number, the filing date, the title of the invention, the inventor, the applicant, and the examiner, for example. The character identification function may be executed by a WINDOWS OCR function, for example.

The fault tolerance module 104 is operable to determine whether the identified character data is erroneous, and to correct the character data being determined to be erroneous. For example, when converting the official notice to the image format document, a number “1” may be read as an erroneous character “I”, and a number “0” may be read as an erroneous character “O.”

The data analysis module 105 is operable to extract patent information of the electronically filed patent application from the character data using a regular expression. In one embodiment, the regular expression is an expression that describes a set of character data, and is used to extract the patent information from the character data. For example, a set of three character data “Hide,” “Hine,” and “Hinge” may be described by the regular expression “Hi(d|ng?)e.” In the regular expression, the vertical bar “1” is used to separate alternatives. The question mark “?” is used to indicate there is zero or one element (here is “g”) to be extracted from the character data.

The data analysis module 105 is further operable to obtain basic information of the patent application from the database 3, and compare the patent information with the basic information. The data analysis module 105 generates analysis results of the official notice according to the comparison, and sends the analysis results to the client computer 4 for the user to review the patent information of the patent application.

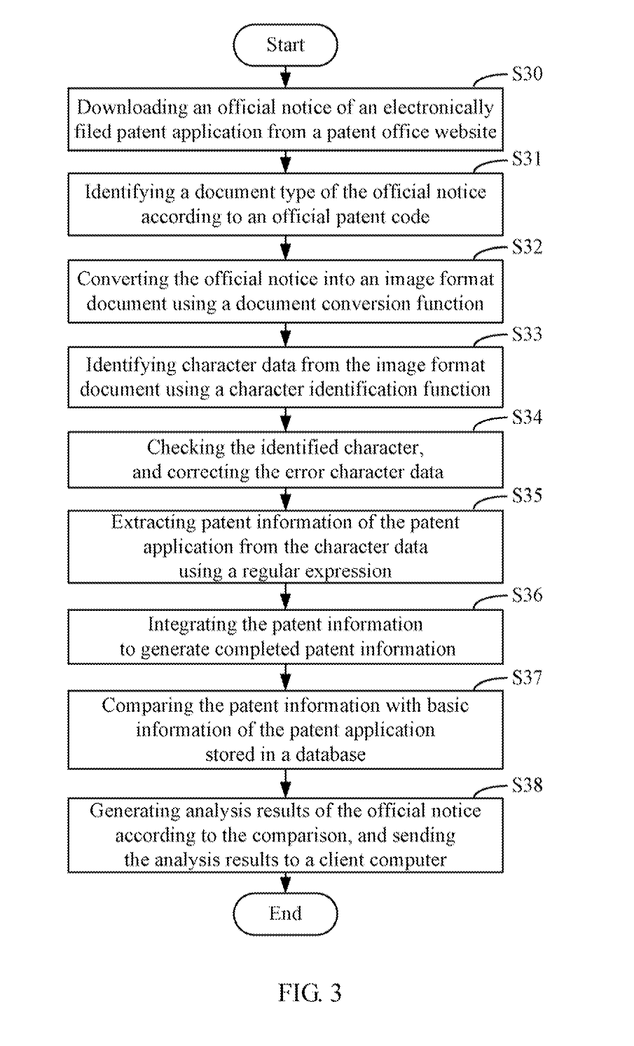

FIG. 3 is a flowchart of one embodiment of a method for analyzing official notices of an electronically filed patent application using a system such as, for example, that of FIG. 1. In the embodiment, the official notices are sent from a patent office during the examination process of the patent application, and may include the filling receipts, the office actions, the notices to file corrected application papers, the notices of missing parts, and so on. Depending on the embodiment, additional blocks may be added, others removed, and the ordering of the blocks may be changed.

In block S30, the download module 101 downloads an official notice of an electronically filed patent application from one of the patent office websites 2 according to a download command input from one of the client computers 4. In block S31, the download module 101 identifies a document type of the official notice according to an official patent code predefined by a patent office. Details of various documents types are mentioned previously above.

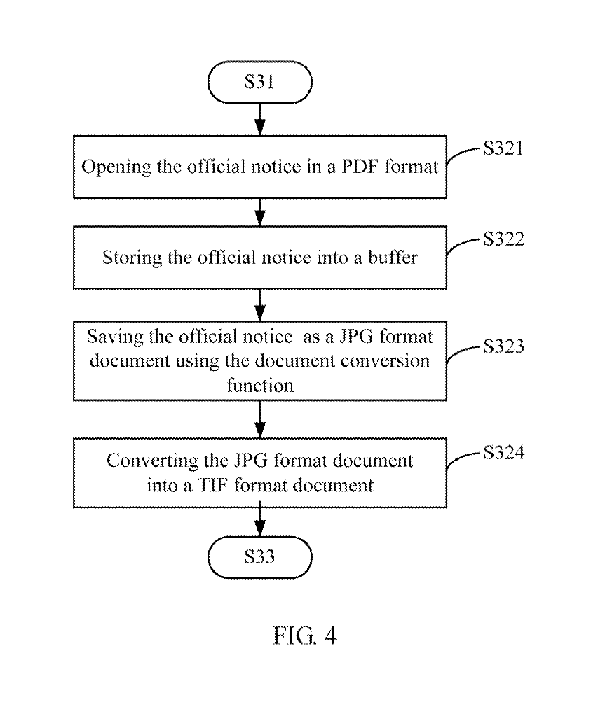

In block S32, the file conversion module 102 converts the official notice to an image format document using a document conversion function. In one embodiment, the image format document may be a JPG format document, or a TIF format document. The document conversion function may be a WINDOWS API function, for example. Details of the conversion are described in FIG. 4 as follows.

In block S33, the character identification module 103 identifies character data from the image format document using a character identification function. In one embodiment, the character data may include information regarding the application number, the filing date, the title of the invention, the inventor, the applicant, and the examiner, etc. The character identification function may be a WINDOWS OCR function, for example.

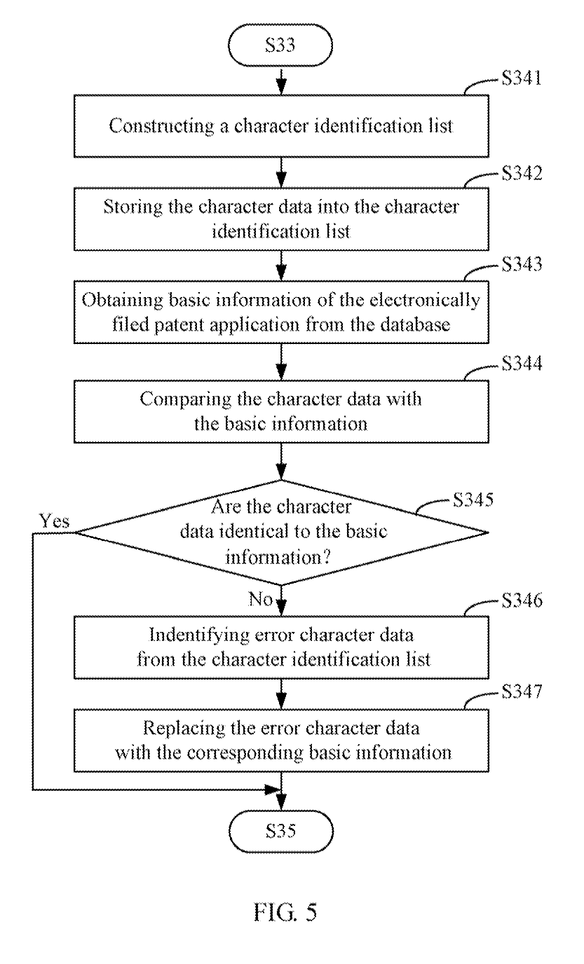

In block S34, the fault tolerance module 104 determines whether the identified character data is erroneous, and corrects character data being determined to be erroneous. For example, when converting the official notice to the image format document, a number “1” may be read as an erroneous character “I”, and a number “0” may be read as an erroneous character “O.” Details of the correction are described in FIG. 5 as follows.

In block S35, the data analysis module 105 extracts patent information of the electronically filed patent application from the character data using a regular expression. as mentioned above, the regular expression is an expression that describes a set of character data, and is used to extract the patent information from the character data.

In block S36, the data analysis module 105 integrates the patent information to generate completed patent information. For example, if a patent application has several inventors, the data analysis module 105 integrates information of all the inventors to generate the completed inventor information.

In block S37, the data analysis module 105 obtains basic information of the electronically filed patent application from the database 3, and compares the patent information with the basic information. In block S38, the data analysis module 105 generates analysis results of the official notice according to the comparison, and sends the analysis results to the client computer 4 via e-mail. The analysis results may be displayed on a display screen of the client computer 4 for the uses to review.

FIG. 4 is a flowchart of detailed descriptions of block S32 in FIG. 3. In block S321, the conversion module 102 opens the official notice in a PDF format. In block S322, the conversion module 102 stores the official notice into a storage buffer of the storage system 12. In block S323, the conversion module 102 saves the official notice as a JPG format document using the document conversion function. In block S324, the conversion module 102 converts the JPG format document into a TIF format document.

FIG. 5 is a flowchart of detailed descriptions of block S34 in FIG. 3. In block S341, the fault tolerance module 104 constructs a character identification list in the storage system 12. In block S342, the fault tolerance module 104 stores the character data into the character identification list. In block S343, the fault tolerance module 104 obtains basic information of the electronically filed patent application from the database 3. In block S344, the fault tolerance module 104 compares the character data with the basic information. In block S345, the fault tolerance module 104 determines whether the character data is identical to the basic information. If the character data is identical to the basic information, block S35 is implemented. If the character data is not identical to the basic information, in block S346, the fault tolerance module 104 identifies error character data from the character identification list. In block S347, the fault tolerance module 104 replaces the error character data with the corresponding basic information.

Although certain inventive embodiments of the present disclosure have been specifically described, the present disclosure is not to be construed as limited thereto. Various changes or modifications may be made to the present disclosure without departing from the scope and spirit of the present disclosure.

What is claimed is:

1. A file server for analyzing official notices of an electronically filed patent application, the file server comprising:
a storage system;
at least one processor; and
an official notice analysis system stored in the storage system and executable by the at least one processor, the official notice analysis system comprising:
a download module operable to download an official notice of the electronically filed patent application from a patent office website according to a download command from a client computer;
a file conversion module operable to convert the official notice to an image format document;
a character identification module operable to identify character data from the image format document;
a fault tolerance module operable to determine whether the identified character data is erroneous, and to correct the character data being determined to be erroneous;
a data analysis module operable to extract patent information of the electronically filed patent application from the character data using a regular expression, to compare the patent information with basic information of the electronically filed patent application stored in a database, to generate analysis results of the official notice according to the comparison, and to send the analysis results to the client computer.

2. The file server according to claim 1, wherein the official notice is a filling receipt, an office action, a notice to file corrected application papers, or a notice of missing parts.

3. The file server according to claim 2, wherein the download module is further operable to identify a document type of the official notice according to an official patent code predefined by the patent office.

4. The file server according to claim 1, wherein the client computers receives one or more official notices from the patent office website during an examination process of the patent application, and displays the analysis results sent by the file server.

5. The file server according to claim 1, wherein the regular expression describes a set of character data, and is used to extract the patent information from the character data.

6. A computer-enabled method for analyzing official notices of an electronically filed patent application, the method comprising:
downloading an official notice of the electronically filed patent application from a patent office website according to a download command from a client computer;
converting the official notice to an image format document;
identifying character data from the image format document;
determining whether the identified character data is erroneous, and correcting the character data being determined to be erroneous;
extracting patent information of the electronically filed patent application from the character data using a regular expression;
analyzing the patent information by comparing the patent information with basic information of the electronically filed patent application stored in a database;
generating analysis results of the official notice according to the comparison; and
sending the analysis results to the client computer.

7. The method according to claim 6, wherein the official notice is a filling receipt, an office action, a notice to file corrected application papers, or a notice of missing parts.

8. The method according to claim 7, further comprising:
identifying a document type of the official notice according to an official patent code predefined by a patent office.

9. The method according to claim 6, wherein the conversion step further comprises:
opening the official notice in a PDF format;
storing the official notice into a storage buffer of a storage system;
saving the official notice as a JPG format document; and
converting the official notice from the JPG format document into a TIF format document.

10. The method according to claim 6, wherein the determination step further comprises:
compiling a character identification list in a storage system;
storing the character data into the character identification list;
obtaining basic information of the electronically filed patent application from the database;
comparing the character data with the basic information;
determining whether the character data is identical to the basic information; and
identifying error character data from the character identification list and replacing the error character data with the corresponding basic information if the character data are not identical to the basic information.

11. The method according to claim 10, wherein the determination step further comprises:
extracting patent information of the electronically filed patent application from the character data if the character data are identical to the basic information.

12. The method according to claim 6, wherein the conversion step is executed by an application programming interface (API).

13. The method according to claim 6, wherein the regular expression describes a set of character data, and is used to extract the patent information from the character data.

14. A storage medium having stored thereon instructions that, when executed by at least one processor of a computing device, cause the computing device to perform a method for analyzing official notices of an electronically filed patent application, the method comprising:
downloading an official notice of the electronically filed patent application from a patent office website according to a download command from a client computer;
converting the official notice to an image format document;
identifying character data from the image format document;
determining whether the identified character data is erroneous, and correcting the character data being determined to be erroneous;
extracting patent information of the electronically filed patent application from the character data using a regular expression;
analyzing the patent information by comparing the patent information with basic information of the electronically filed patent application stored in a database;
generating analysis results of the official notice according to the comparison; and
sending the analysis results to the client computer.

15. The storage medium according to claim 14, wherein the official notice is a filling receipt, an office action, a notice to file corrected application papers, or a notice of missing parts.

16. The storage medium according to claim 15, wherein the method further comprises:
identifying a document type of the official notice according to an official patent code predefined by a patent office.

17. The storage medium according to claim 14, wherein the conversion step comprises:
opening the official notice in a PDF format;
storing the official notice into a storage buffer of a storage system;
saving the official notice as a JPG format document; and
converting the official notice from the JPG format document into a TIF format document.

18. The storage medium according to claim 14, wherein the determination step comprises:
constructing a character identification list in a storage system;
storing the character data into the character identification list;
obtaining basic information of the electronically filed patent application from the database;
comparing the character data with the basic information;
determining whether the character data are identical to the basic information; and
identifying error character data from the character identification list and replacing the error character data with the corresponding basic information, if the character data are not identical to the basic information.

19. The storage medium according to claim 16, wherein the determination step comprises:
determining whether the identified character data is erroneous, and correcting the error character data if the character data are identical to the basic information.

20. The storage medium according to claim 14, wherein the regular expression describes a set of character data, and is used to extract the patent information from the character data.
